(19) United States
(12) Patent Application Publication
(10) Pub. No.: US 2008/0289309 A1
(43) Pub. Date: Nov. 27, 2008

(54) Mower with Hybrid Prime Mover Having Fuel Cell, Brushless Electric Motors for Driving Cutting Units, and Electric/Hydraulic Actuator for Lift and Lower System

(76) Inventors: Jackie R. Gust, Northfield, MN (US); Mark S. Anderson, Prior Lake, MN (US)

Correspondence Address: JAMES W. MILLER, ATTORNEY, 527 MARQUETTE AVENUE, SUITE 1960, RAND TOWER, MINNEAPOLIS, MN, 55402, US

(21) Appl. No.: 11/883,978

(22) PCT Filed: Feb. 8, 2006
(86) PCT No.: PCT/US2006/004336

§ 371 Date: May 12, 2008

Related U.S. Application Data
(60) Provisional application No. 60/651,315, filed on Feb. 9, 2005.

(51) Int. Cl. A01D 34/24

(52) U.S. Cl. 56/11.9; 56/229

(57) ABSTRACT

This invention relates to a hybrid lawn mower powered by a fuel cell and an electrical storage system, both of which supply electric power to the drive wheels and cutting units of the mower. The electrical storage system comprises an ultracapacitor pack or a battery pack. The electric motor driving each cutting unit comprises a brushless motor having an integrated gear reduction stage. In addition, the motor includes an integrated electronics housing in which the electronics for controlling and powering the motor are packaged. The cutting units are lifted out of engagement with the ground by a lift and lower system comprising an electric/hydraulic actuator that is driven only during lifting of the cutting units. The cutting units are lowered by releasing fluid pressure in the lift and lower system and permitting the force of gravity to lower the cutting units.

### CROSS REFERENCE TO RELATED APPLICATIONS

This application claims the benefit of one or more previously filed copending provisional applications identified as follows: Application Ser. No. 60/651,315 filed Feb. 9, 2005.

### TECHNICAL FIELD

This invention relates to an electrically powered mower having a plurality of reel type cutting units for mowing grass.

### BACKGROUND OF THE INVENTION

Hybrid driven mowers are known in which an internal combustion engine and battery pack combination is used to power the mower. One such mower includes electrical drive motors for propelling the drive wheels of the mower as well as electrical motors for powering a plurality of cutting reels. The electrical energy for driving such motors is supplied by an alternator on the internal combustion engine and, when needed, by the battery pack as well. A hybrid mower of this type is disclosed in International Publication Number WO 97/28681.

While a hybrid mower as described above is more efficient in using gasoline or diesel fuel, it nonetheless retains the use of an internal combustion engine. Consequently, such a mower still burns a fossil fuel. The burning of such a fuel emits various pollutants including carbon dioxide, a suspected cause of global warming. In addition, the operation of an internal combustion engine is noisy. It would be advantageous if such a mower were powered, at least in part, by a more environmentally friendly prime mover.

Another problem with mowers of this type is the design of the electric motors that power various components on the mower, including the rotatable cutting reels of the cutting units. Conventional motors are relatively large in size. Brushless motors are smaller but rotate at speeds higher than that required by the cutting reel, thus necessitating the use of some type of speed reduction. Thus, the packaging and mounting of such motors on a cutting reel present various challenges.

Moreover, if one uses a brushless electric motor, then various control electronics are required to operate the motor. Such electronics have typically been packaged separately from the motor and have been connected to the motor by a wiring harness. This is unduly cumbersome. It would be an advance in the art to find a way to minimize the amount of space and wiring required for the control electronics, namely to simplify the motor design.

Finally, in most mowers, a lift and lower system is provided for lifting the cutting units into and out of engagement with the ground. Such a system is typically hydraulically powered with a pump being driven by the engine to pump hydraulic fluid to actuators used in the lift and lower system. The pump generally operates continuously and circulates fluid to the actuators or in a loop back to the reservoir. This causes the hydraulic fluid, which is typically an oil of some type, to heat. If any leaks develop in this hydraulic power system, such leaks of a heated oil onto the turf can damage the turf, which is obviously undesirable. It would be further advantageous to find a way to minimize the impact of any hydraulic oil leaks.

### SUMMARY OF THE INVENTION

One aspect of this invention relates to an electrically driven turf maintenance machine. The machine comprises a frame. A plurality of ground engaging wheels attached to the frame support the frame for movement over the ground. At least one electric motor is operatively connected to at least one of the ground engaging wheels for propelling the wheel to provide traction for the frame. At least one operating unit is carried on the frame for performing a turf maintenance operation. At least one electric motor is operatively connected to at least one operating unit for powering the operating unit. An electric drive system is carried on the frame for providing electric power to the electric motors. The electric drive system comprises a fuel cell capable of converting hydrogen gas into electric power and an electrical storage system for storing electric power.

Another aspect of this invention relates to a reel type cutting unit of a mower. The cutting unit comprises a cutting unit frame comprising a pair of laterally spaced side plates. A rotatable cutting reel is cooperable with a fixed bedknife to sever grass, the cutting reel being rotatably journalled in the side plates for rotation between the side plates. An electric motor is carried on an exterior of one of the side plates for powering the cutting reel. The electric motor comprises a motor housing having a rotatable motor armature and an output shaft driven from the motor armature with the output shaft being coupled to the cutting reel for rotating the cutting reel. The output shaft is lower than the motor armature when the output shaft is coupled to the cutting reel.

Yet another aspect of this invention relates to an electric motor for powering a rotatable cutting reel of a reel type cutting unit of a mower. The motor comprises a motor housing having a rotatable motor armature. The motor armature is operatively coupled to the cutting reel for rotating the cutting reel. An electronics housing is integral with the motor housing. The electronics housing contains the electronics for controlling and powering the motor.

An additional aspect of this invention relates to a mower which comprises a frame. A plurality of ground engaging wheels attached to the frame support the frame for movement over the ground. A traction system is operatively connected to at least one of the ground engaging wheels for propelling the wheel to provide traction for the frame. At least one grass cutting unit is carried on the frame for cutting grass. A lift and lower system is provided for lifting the cutting unit out of engagement with the ground and for lowering the cutting unit into engagement with the ground. An actuator powers the lift and lower system during lifting of the cutting units out of engagement with the ground with the actuator being unpowered during lowering of the cutting units into engagement with the ground.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a perspective view of an electrically powered, hybrid mower according to this invention;

FIG. 2 is a side elevational view of the mower of FIG. 1, particularly illustrating the reel cutting units in a lowered mowing position;

FIG. 3 is a rear elevational view of the mower of FIG. 1;

FIG. 4 is a front elevational view of the mower of FIG. 1;

FIG. 5 is a side elevational view of the mower of FIG. 1, particularly illustrating the side of the mower that is opposite to the side of the mower depicted in FIG. 2;

FIG. 6 is a side elevational view similar to FIG. 2, but particularly illustrating the reel cutting units in a raised transport position;

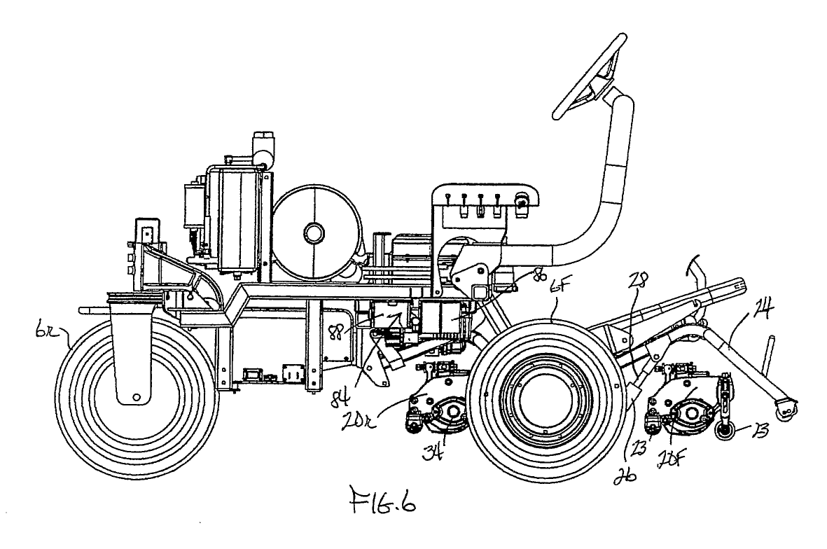

FIG. 7 is an enlarged perspective view of one of the reel cutting units of the mower of FIG. 1;

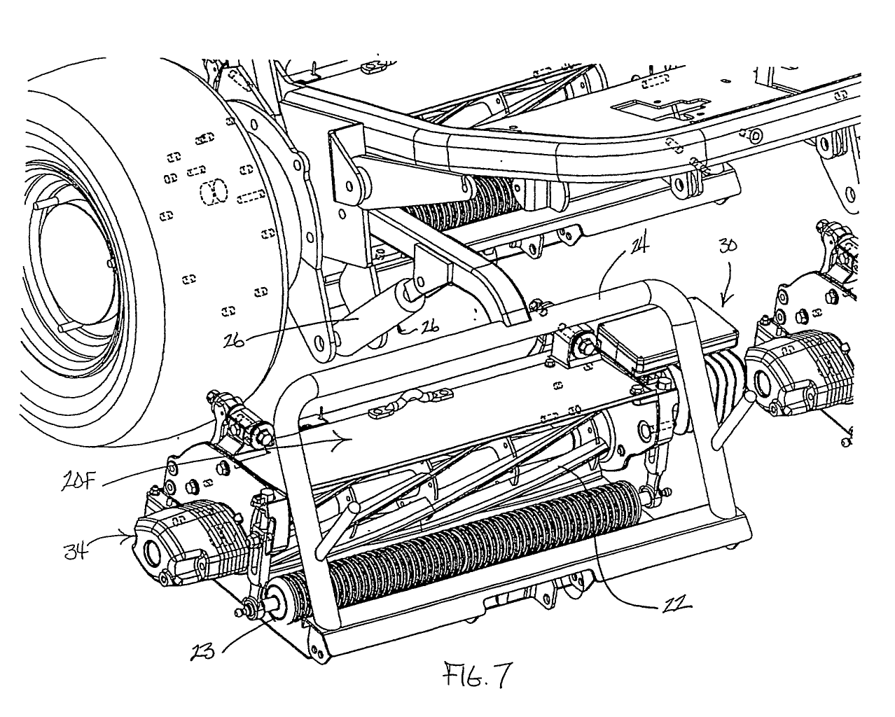

FIG. 8 is an enlarged perspective view of one end of one of the reel cutting units of the mower of FIG. 1, particularly illustrating the brushless electric motor used to drive the rotatable reel of the reel cutting unit;

FIG. 9 is an enlarged rear elevational view of one end of one of the reel cutting units of the mower of FIG. 1, particularly illustrating the brushless electric motor used to drive the rotatable reel of the reel cutting unit;

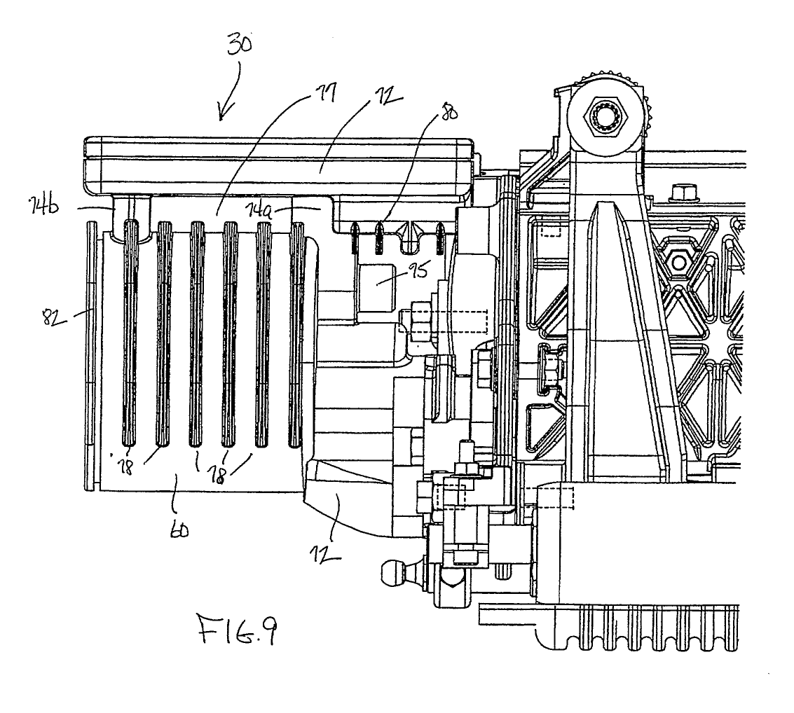

FIG. 10 is a front elevational view of one of the brushless electric motors used to drive one rotatable reel on the mower of FIG. 1;

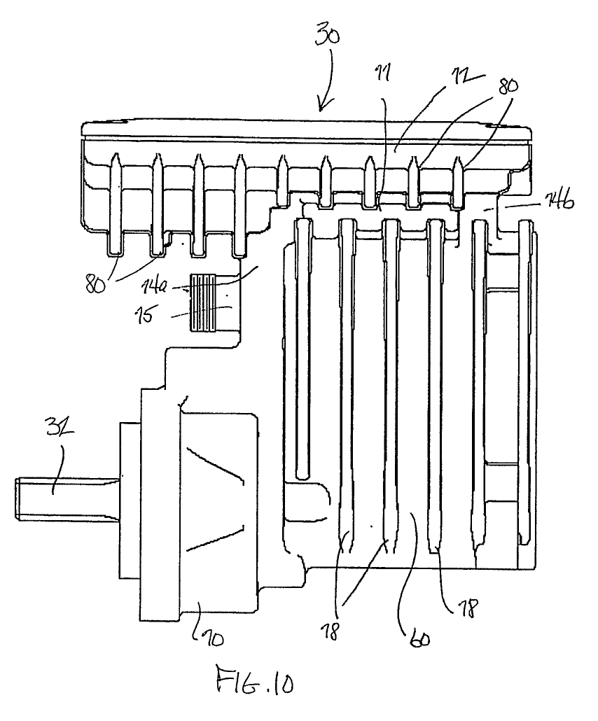

FIG. 11 is a cross-sectional view through the brushless electric motor shown in FIG. 10;

FIG. 12 is an enlarged perspective view of the electric/hydraulic actuator used to power the hydraulic cylinders that raise and lower the reel cutting units on the mower of FIG. 1;

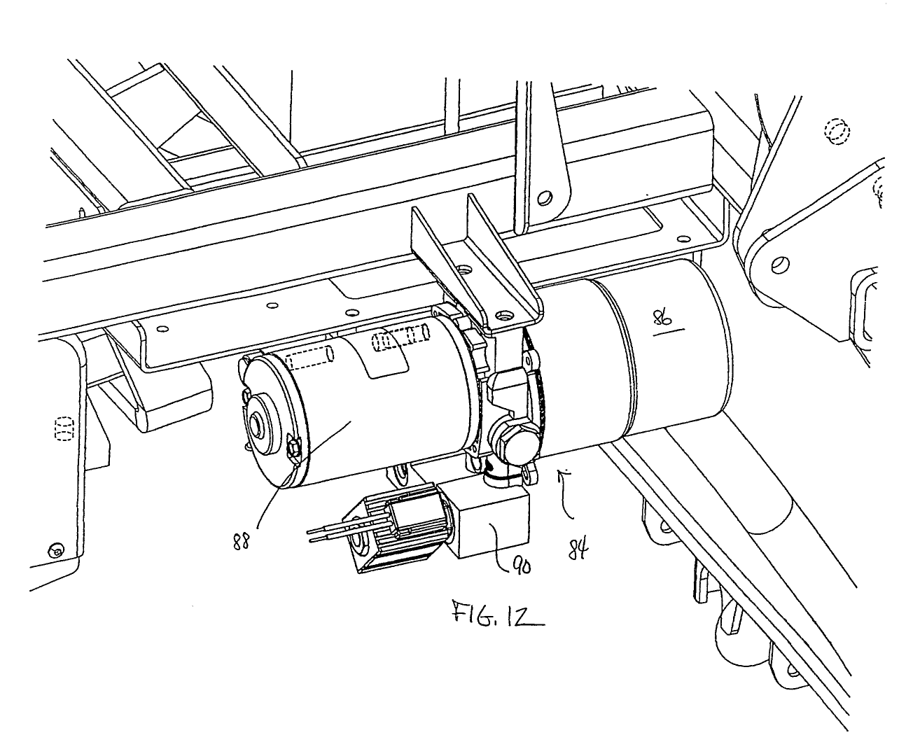

FIG. 13 is an enlarged perspective view of a portion of the mower shown in FIG. 1, particularly illustrating the mower with the operator's seat removed to illustrate a first embodiment of a hybrid power system for the mower comprising an ultracapacitor pack/fuel cell power system; and

FIG. 14 is an enlarged perspective view of a portion of the mower shown in FIG. 1, particularly illustrating the mower with the operator's seat removed to illustrate a second embodiment of a hybrid power system for the mower comprising a battery pack/fuel cell power system.

### DETAILED DESCRIPTION

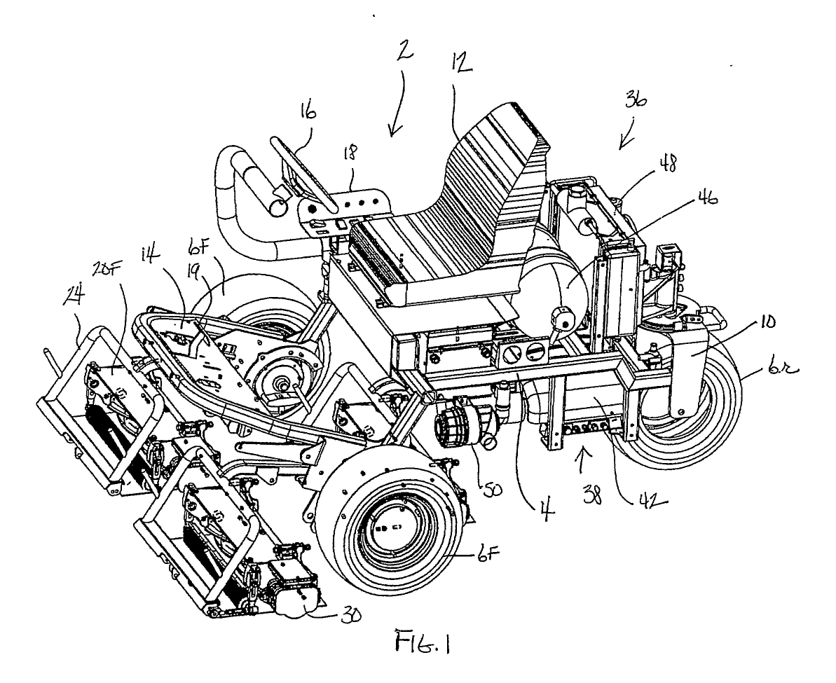

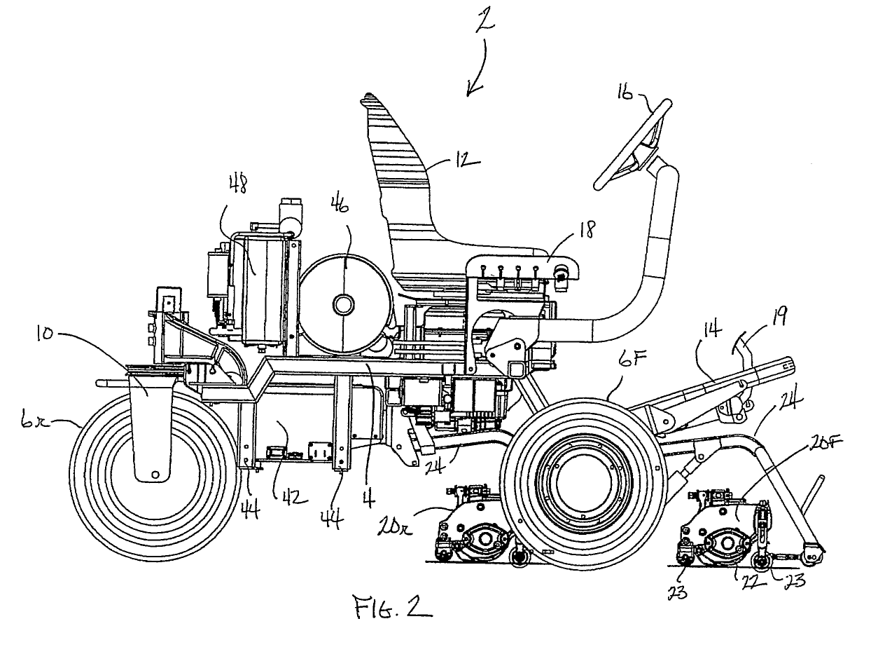

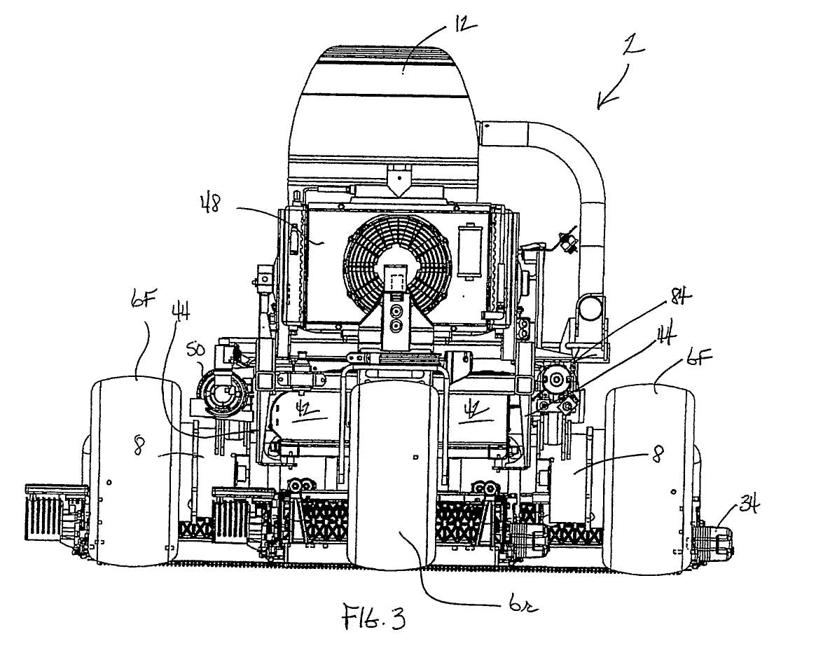

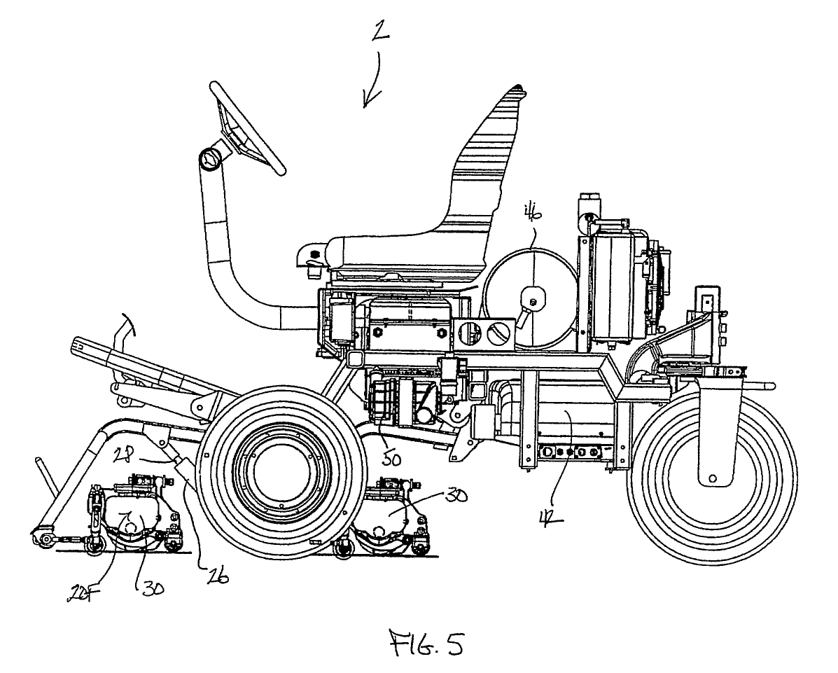

One embodiment of an electrically powered, hybrid mower according to this invention is illustrated generally 2 as in FIGS. 1-5. Mower 2 comprises a traction frame 4 that is supported for rolling over the ground by a plurality of ground engaging wheels 6. The wheels preferably comprise a pair of front drive wheels 6f and a rear steerable wheel 6r arranged in a tricycle configuration as shown. However, the number of wheels 6, the configuration of the wheels 6 on frame 4, which wheels 6 are drive wheels 6f and which wheels 6 are the steerable wheels, etc., can vary from that depicted herein. All wheels 6 could be drive wheels if so desired.

Drive wheels 6f are each driven by individual electric motors 8 operatively connected to drive wheels 6f to rotate drive wheels 6f when drive motors 8 are powered. Drive motors 8 can propel drive wheels 6f directly or through some type of speed reduction device such as a gear or belt drive having at least one speed reduction stage. Rear wheel 6r is not driven but is supported by a pivotal yoke 10 for turning from side to side about a vertical axis.

A seat 12 is carried on frame 4 for supporting a seated operator. A floorboard 14 and a steering wheel 16 are provided ahead of seat 12. A control console 18 with various operational controls and informational displays is provided along one side of seat 12, but could be located in a number of alternative convenient locations. As an operator sits on seat 12, the operator can place his or her feet on floorboard 14, can grip steering wheel 16, and can easily reach and actuate the controls and view the informational displays on control console 18.

Floorboard 14 will have various pedals 19, such as traction and brake pedals, for permitting the operator to control the forward and reverse propulsion of mower 2. For example, the traction pedal can be a rocker type pedal that is pivotal in opposed directions about a center pivot. The operator can rotate the pedal in one direction by depressing the front of the traction pedal with the toes of the operator's foot to drive mower 2 in a forward direction and in the opposite direction by depressing the rear of the traction pedal with the heel of the operator's foot to drive mower 2 in a reverse direction. An electronic controller (not shown) will apply power to drive motors 8 in amounts proportional to the amount of rotation of the traction pedal from a neutral position to control the speed of movement of mower 2.

The operator can turn steering wheel 16 from one side to the other to turn mower 2 in a desired direction. Rotation of steering wheel 16 causes rear wheel 6r to be pivoted about its vertical pivot axis to effect the desired turn. In addition, the electronic controller controlling the application of power to drive motors 8 can simultaneously decrease the power to drive motor 8 propelling front drive wheel 6f on the inside of the turn and can increase the power to drive motor 8 propelling front drive wheel 6f on the outside of the turn. This provides a differential like action for drive wheels 6f that avoids skidding or dragging of drive wheels 6f on the turf during the turn.

Alternatively, the electronic controller controlling the application of power to drive motors 8 can slow down the drive motor 8 propelling front drive wheel 6f on the inside of the turn proportional to the turn angle while maintaining the drive motor propelling front drive wheel 6f on the outside of the turn at the same speed per the speed command established by the position of the accelerator pedal. In effect, this desirably provides a slow-in-turn feature. The tighter mower 2 turns, the slower the ground speed of mower 2. This helps drivability as the operator can keep the accelerator pedal floored throughout the turn since mower 2 will automatically slow during turns. More importantly, this dramatically helps reduce turf damage from aggressive turns.

While driving drive wheels 6f through individual electric motors 8 is preferred, a single electric motor 8 driving drive wheels 6f through a transaxle could be used. Such a transaxle would have a built in differential to allow drive wheels 6f to rotate at different speeds during a turn.

Mower 2 carries three reel type cutting units 20 comprising a pair of front cutting units 20f and a center rear cutting unit 20r. Front cutting units 20f are arranged ahead of drive wheels 6f of mower 2. Rear cutting unit 20r is arranged generally beneath operator's seat 12 and between drive wheels 6f and rear wheel 6r. Rear cutting unit 20r is arranged to cover the gap between front cutting units 20f such that the three cutting units 20 collectively cut a relatively wide, unbroken swath of grass. A mower equipped with this type of cutting unit arrangement is often referred to in the commercial mower art as a triplex mower.

While a triplex mower has been shown herein for illustrative purposes, this invention is not limited to such a mower. Instead, mower 2 could be a fiveplex or sevenplex mower having five or seven reel cutting units, namely three front cutting units and two (or 4) trailing rear cutting units. Moreover, the order of cutting units 20 could be reversed with the front and rear cutting units exchanging positions, e.g. a triplex mower would now have a single center front cutting unit and two trailing rear cutting units. Cutting units 20 need not be carried directly on frame 4 of mower 2, but could be carried on a trailed frame that is towed behind mower 2 or some other vehicle.

Each cutting unit 20 comprises a conventional reel type cutting unit of the type having a rotatable reel 22, a fixed bedknife (not shown), and one or more ground engaging rollers 23 for supporting cutting unit 20 for rolling over the ground. Reel 22 rotates during operation of cutting unit 20 to sever grass against the bedknife. Cutting unit 20 is flexibly suspended from a carrier frame 24 to allow cutting unit 20 to have various degrees of freedom to adapt to the contours of the ground. Allowing cutting unit 20 to at least pitch about a horizontal transverse axis and/or to roll about a horizontal longitudinal axis is fairly common in the art.

A lift and lower system is provided on mower 2 for raising cutting units 20 from a lowered mowing position in which cutting units 20 contact the ground to an elevated transport position in which cutting units 20 are raised and held out of contact with the ground. Each carrier frame 24 is pivotally mounted on frame 4 for pivotal motion about a substantially horizontal pivot axis. An individual hydraulic cylinder 26 extends between frame 4 and carrier frame 24 so that carrier frame 24 is pivoted upwardly about its pivot axis when piston rod 28 of hydraulic cylinder 26 is extended and is pivoted downwardly about its pivot axis when piston rod 28 of hydraulic cylinder 26 is retracted. A plurality of lifting chains or the like (not shown) extend between each carrier frame 24 and each corresponding cutting unit 20. Thus, cutting unit 20 is carried upwardly off the ground and placed into its transport position by the tightening of the lifting chains as carrier frame 24 is pivoted upwardly, which chains are normally slack when cutting unit 20 is in its lowered mowing position.

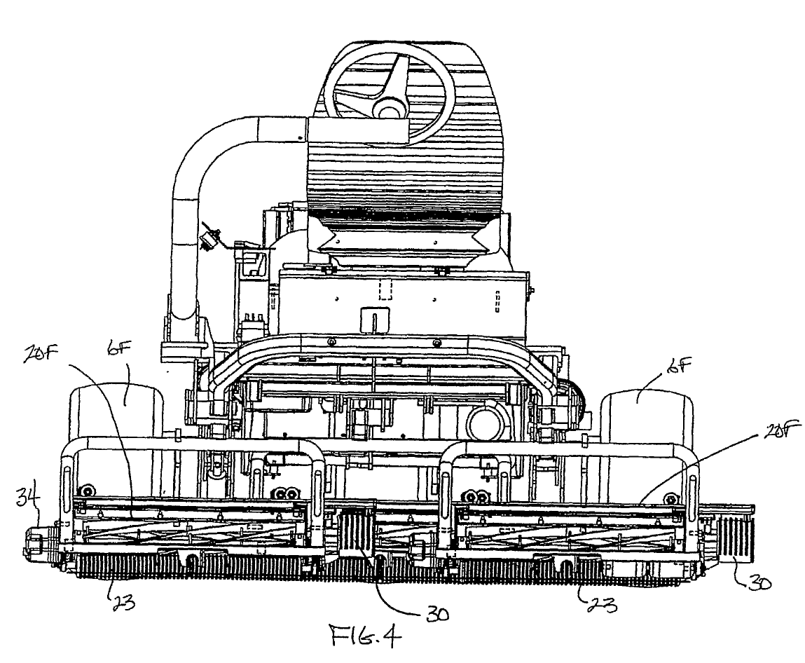

Each cutting unit 20 is powered by its own individual electric motor 30. Output shaft 32 of cutting unit motor 30 is coupled through any suitable connection to the shaft of reel 22 such that reel 22 rotates when cutting unit motor 30 is energized. Cutting unit motor 30 is carried on one side of each cutting unit 20 and a counterweight 34 is placed on the other side of cutting unit 20 to help balance the weight of cutting unit motor 30. As shown in FIG. 4, cutting unit motors 30 for front cutting units 20f can be placed on the same sides of each front cutting unit. Alternatively, cutting unit motors 30 could be placed adjacent one another on the inboard sides of front cutting units 20f, i.e. motor 30 for the left front cutting unit 20f could be moved from the outboard to the inboard side of left front cutting unit 20f to be more protected and less susceptible to damage.

One aspect of this invention relates to a hybrid prime mover 36 for providing electrical power to operate mower 2. Prime mover 36 comprises a fuel cell system 38 for generating electrical energy and an electrical storage system 40 for storing electrical energy. The electrical output of fuel cell system 38 is coupled to storage system 40. The various electrical motors described above, namely drive motors 8 and cutting unit motors 30, are electrically coupled to storage system 40 for receiving electrical energy from prime mover 36. When the electrical energy from fuel cell system 38 is less than the electrical energy required by cutting unit motors 30, then storage system 40 will supply the deficit to satisfy the instantaneous power requirements of mower 2. When the electrical energy being output from fuel cell system 38 is more than the electrical energy required by cutting unit motors 30, then the excess power and any power derived from regenerative braking can be used to recharge storage system 40.

Fuel cell system 38 of prime mover 36 is carried on frame 4 of mower 2 behind operator's seat 12 but forwardly of rear wheel 6r. Fuel cell system 38 comprises a fuel cell 42, such as a Hydrogenics HyPM-7U fuel cell rated at 7 kw, carried on an underside of frame 4 by a pair of L-shaped side mounts 44 on each side of frame 4. The placement of fuel cell 42 beneath frame 4 forwardly of rear wheel 6r and the protection afforded fuel cell 42 by side mounts 44 help protect fuel cell 42 from damage. Fuel cell 42 creates electrical energy by converting hydrogen gas into such energy in a chemical reaction of the type well known with respect to the fuel cell art.

Fuel cell system 38 also comprises other components as are well known in the fuel cell art. These components include a composite storage tank 46 for storing a supply of compressed hydrogen gas, a radiator 48 for supplying a flow of cooling water for cooling fuel cell 42 during operation of fuel cell 42, and an air filter 50 for supplying clean air to fuel cell 42. Storage tank 46 is mounted on frame 4 of mower 2 between operator's seat 12 and radiator 48 to help protect storage tank 46. Air cleaner 50 is mounted along one side of frame 4 generally beneath frame 4 and close to fuel cell 42. Mower 2 can include a hood or cover (not shown) for enclosing fuel cell system 38 or portions thereof provided that radiator 48 would be exposed in some way to have access to cooling air.

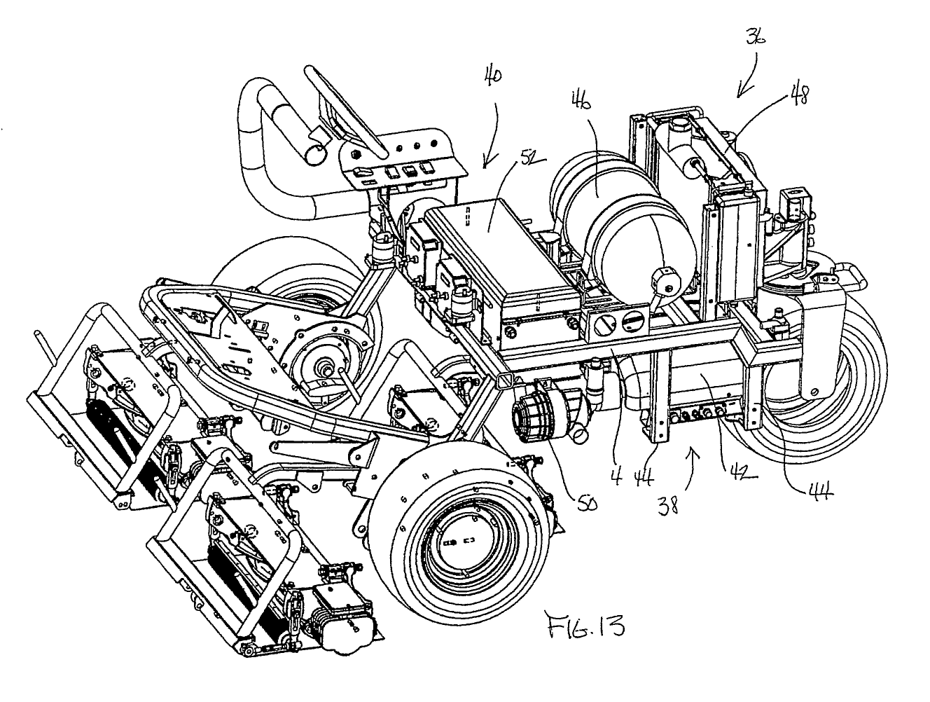

Storage system 40 is placed on top of frame 4 beneath operator's seat 12. As shown in FIG. 13, a first embodiment of storage system 40 is an ultracapacitor pack 52 comprising a box for storing a plurality of ultracapacitors (not shown). Ultracapacitors are known electrical storage devices. Ultracapacitors have the capability of supplying relatively high peak power for relatively short periods of time compared to batteries. This would provide quick bursts of high power when needed such as during acceleration of mower 2.

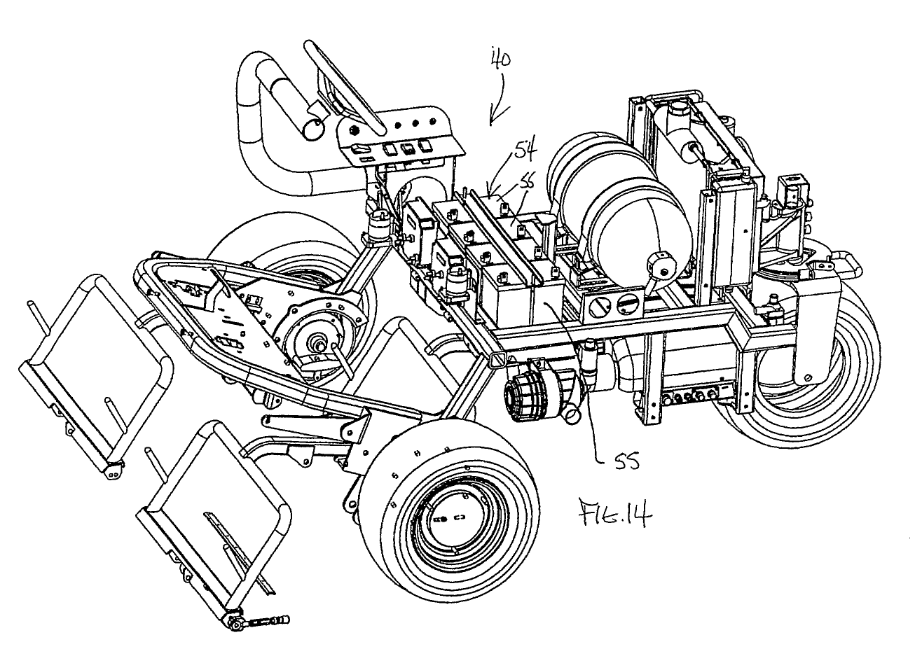

Alternatively, as shown in FIG. 14, storage system 40 could comprise a battery pack 54 comprising a plurality of batteries 55, such as automotive type 12 Volt batteries of conventional design. Since 48 Volt electrical power is supplied from prime mover 36 to drive the various electrical motors 8 and 30, four 12 Volt storage batteries would be used in such a battery pack 54. Compared to ultracapacitor pack 52, a battery pack 54 can supply electrical power at lower peak amounts but for a much longer time. If desired, storage system 40 could comprise both an ultracapacitor pack 52 and a battery pack 54.

Batteries 55 can have various battery chemistries. For example, batteries 55 can be typical automotive type lead-acid batteries. Alternatively, batteries 55 can comprise higher performance batteries such as Ni-MH (Nickel-Metal hydride) or Li-Ion (Lithium Ion) batteries.

The hybrid prime mover 36 disclosed herein has various advantages. Prime mover 36 is efficient because the relatively expensive fuel cell system 38 only has to supply the average power while storage system 40 provides the peak power. A hybrid prime mover 36 using a fuel cell system 38 is preferred over a hybrid using an internal combustion engine because fuel cell system 38 is quieter and produces cleaner emissions than an internal combustion engine. Finally, a hybrid prime mover 36 using a fuel cell system 38 is preferred over an all battery system because it can be quickly refueled, thus providing extended range, and is lightweight, which is valuable for turf applications.

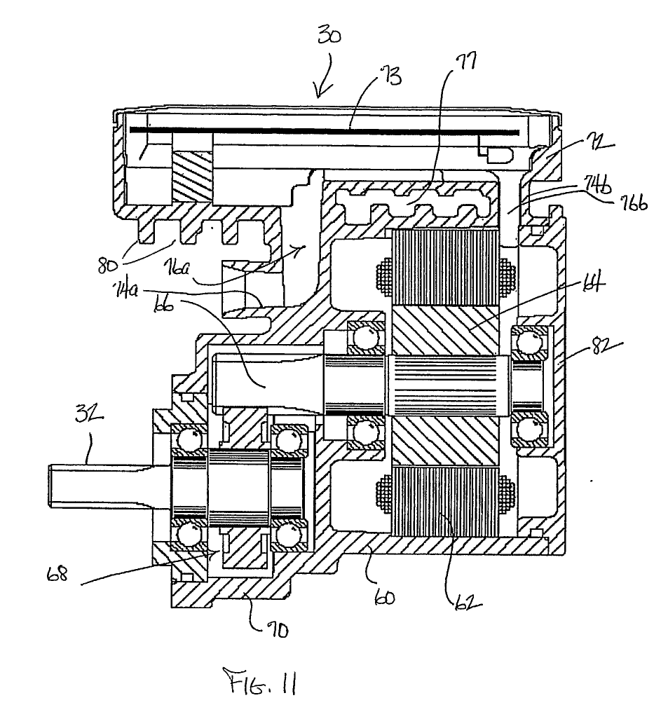

Another aspect of this invention relates to an improved, bi-directional brushless electric motor used as cutting unit motor 30. Referring to FIGS. 20 and 11, cutting unit motor 30 comprises a cylindrical motor housing 60 having motor windings 62 that surround an internal array 64 of magnets carried around a motor armature 66. Motor armature 66 rotates output shaft 32 through a single gear reduction stage 68 housed in an integrated gear reduction housing 70. Gear reduction housing 70 extends downwardly from motor housing 60 such that output shaft 32 is lower than motor armature 66. Thus, motor housing 60 has increased ground clearance when output shaft 32 is connected to reel 22. This helps minimize inadvertent contact or bumping of motor housing 60 on the ground especially when mower 2 is traversing uneven terrain.

Another feature of cutting unit motor 30 is the use of on-board electronics of the type needed to power and control cutting unit motor 30. Cutting unit motor 30 comprises an integrated electronics housing 72 that encloses a printed circuit board 73 and the other electronic components needed for controlling and powering cutting unit motor 30. Electronics housing 72 stands off from motor housing 60 but is connected to motor housing 60 through two ribs or posts 74 that provide wire passages 76. As shown, electronics housing 72 overlies both motor housing 60 as well as gear reduction housing 70 such that electronics housing 72 extends outwardly past the end of motor housing 60 and above gear reduction housing 70. The portion of electronics housing 72 overlying motor housing 60 is separated from motor housing 60 by a gap 77 located between posts 74 that unite electronics housing 72 with motor housing 60.

One post 74a that joins electronics housing 72 to motor housing 60 is located at one end of motor housing 60 and is substantially L-shaped having a free end 75 providing an access opening into electronics housing 72. Wire passage 76a formed in post 74a is L-shaped as well and is big enough to accept the following wires (not shown) two 48 Volt power wires for powering cutting unit motor 30, two 14 Volt power wires for powering circuit board 73 and the other electronics housed within electronics housing 72, two controller area network (CAN) wires for allowing communication with and some control by a master controller (not shown) on mower 2, and an identification wire for reporting to the master controller which cutting unit 20 is being driven by that particular cutting unit motor 30. The other post 74b that joins electronics housing 72 to motor housing 60 is located adjacent the opposite end of motor housing 60. The wire passage 76b formed in post 74b is simply a vertical passage that is big enough to pass three 3-phase power wires from the electronics down to motor windings 62 and six signal wires.

U.S. Pat. No. 6,230,089 is assigned to the assignee of this invention and is hereby incorporated by reference. The 089 patent teaches a CAN control system utilizing a primary controller on a mower and a number of secondary or slave controllers for the individual cutting units. Mower 2 of this invention can utilize this type of CAN control system with the slave controller for each cutting unit 20 being incorporated as part of the electronics on printed circuit board 73.

Motor housing 60 of cutting unit motor 30 is provided with a plurality of cooling fins 78 integrally molded or cast thereon. This aids in heat dissipation from cutting unit motor 30. Motor housing 60, gear reduction housing 70, and electronics housing 72 are all preferably formed as an integral housing cast from any suitable metallic material.

In addition, electronics housing 72 is also provided with a plurality of cooling fins 80 integrally molded or cast on the underside of electronics housing 72. Such cooling fins 80 could be placed only on that portion of the underside of electronics housing 72 that projects beyond motor housing 60 or all along the underside of electronics housing 72 including in gap 77 between connecting posts 74. Such cooling fins 80 on electronics housing 72, as well as the fact that electronics housing 72 is largely separated from motor housing 60 by gap 77, helps keep the temperature in electronics housing 72 in a range in which the electronics on printed circuit board 73 can survive. Additional cooling fins 80 could also be placed on top of electronics housing 72 if so desired.

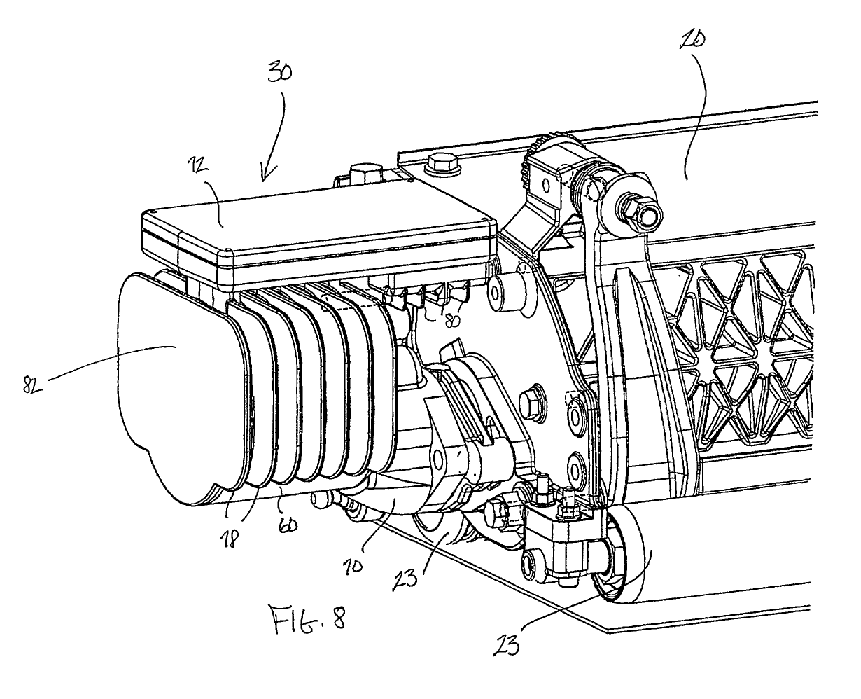

One end of cutting unit motor 30 is provided with a removable end cap 82 to allow assembly of cutting unit motor 30. End cap 82 can be secured to motor housing 60 by various threaded machine screws or bolts (not shown) that removably attach end cap 82 to motor housing 60. Rivets could also be used to more permanently attach end cap 82 to motor housing 60. End cap 82 is also shaped much like the other cooling fins 78 on the rest of motor housing 60 to function as an additional cooling fin. See. FIG. 8. The outer peripheral portions of end cap 82 forming the projecting cooling fin 78 could be scored relative to the central portion of end cap 82. Thus, if the cooling fin portion of end cap 82 strikes an obstruction during operation of mower 2, the cooling fin portion of end cap 82 can break away without damaging the central portion of end cap 82.

Cutting unit motor 30 of this invention affords the commercial mowing art various advantages. The use of an on-board electronics housing 72 for the on-board packaging of printed circuit board 73 provides a much simpler and cleaner overall design than has been done in the past. In addition, the Applicants have improved heat dissipation by having heat dissipating fins 78 over the major portion of cylindrical motor housing 60, by standing electronics housing 72 off from motor housing 60 by gap 77, and by using cooling fins 80 on electronics housing 72 as well. Accordingly, cutting unit motor 30 disclosed herein is a simple and durable way of rotating reel 22 of cutting unit 20.

The use of a brushless electric motor 30 rotating at a higher speed than the speed of rotation of reel 22, i.e. 6,000 rpm vs. 2,000 rpm, along with a gear reduction stage 68 is also advantageous. Higher speed brushless electric motors are lighter than their lower speed counterparts and thus mimic the typical size and weight of the hydraulic motors that have traditionally powered reels 22. In addition, while a gear reduction stage 68 is needed to reduce the speed of motor 30, by placing the gear reduction stage 68 below motor armature 66, motor housing 60 is raised relative to reel 22 to improve the ground clearance of cutting unit motor 30.

Yet another aspect of this invention relates to how hydraulic cylinders 26 in the lift and lower system for cutting units 20 are powered. In conventional mowers that utilize hydraulic motors for driving both drive wheels 6f and cutting units 20, mower 2 includes a large hydraulic drive system that includes a pump for pumping hydraulic fluid from a reservoir to the various hydraulic motors and cylinders. The pump operates continuously during operation of mower 2, reservoir 86 holds a large amount of hydraulic oil, and the oil becomes relatively hot. There are many connecting hoses as well. Thus, there is the potential for a leak of hot hydraulic oil which can be damage the turf.

In this invention, an integrated electric/hydraulic actuator 84 is used having a small reservoir 86 of hydraulic oil, an electric motor/pump 88 for pumping fluid from reservoir 86, and a solenoid operated valve 90 for supplying the pumped hydraulic oil to a plurality of outlets, all packaged together as a single self-contained unit. Normally, actuator 84 is inactive with motor/pump 88 not being driven. However, when the operator wishes to raise cutting units 20 and throws or activates a control switch (not shown) to do the same, motor/pump 88 is driven to thereby pump the hydraulic oil through the outlets of valve 90. A single hose (not shown) connects each valve outlet to one hydraulic cylinder 26 to supply the pressurized oil to the backside of piston rod 28 to cause piston rod 28 to extend to raise cutting unit 20. When cutting units 20 reach their raised transport positions, motor/pump 88 is deactivated and valve 90 is closed to block the valve outlets and prevent the return of the hydraulic oil to reservoir 86, thereby maintaining cutting units 20 in their raised transport positions.

Cutting units 20 can then be lowered simply by opening valve 90 to unblock the valve outlets, i.e. by placing actuator 84 in a float mode. Then, the weight of cutting units 20 on carrier frames 24 will simply lower cutting units 20 and simultaneously force the hydraulic oil in hydraulic cylinders 26 back into reservoir 86 of actuator 84. Actuator 84 as used herein can be a Parker Oildyne 108 Series Hydraulic Power Unit (Model No. 108IJS32BS11A2000).

Using an electric/hydraulic actuator 84 of the type disclosed herein has a number of advantages. There are far fewer connecting hoses as only one hose is needed to extend between actuator 84 and each hydraulic cylinder 26. The amount of oil in the system is small and the oil stays relatively cool since motor/pump 88 is driven only when the lift and lower system is actuated and only during the brief time needed to raise cutting units 20. Thus, hydraulic oil leaks and particularly leaks of hot hydraulic oil are either eliminated or greatly reduced. In addition, it is preferable to use biodegradable oil to further reduce the potential of turf damage.

Various other modifications of this invention will be apparent to those skilled in the art. For example, two cutting unit motors 30 could simultaneously drive a reel 22 of one cutting unit 20, each motor 30 being mounted on each side of cutting unit 20 for simultaneously driving both ends of the shaft of reel 22. A cutting unit 20 equipped with two such cutting unit motors 30 would not have a counterweight 34 as the weight of motors 30 would balance one another. The control and/or motor electronics would allow such dual drive motors 30 to equally share the load of driving reel 22, a non-trivial task to accomplish otherwise. In addition, by using two cutting unit motors 30 to double the power to reel 22, heavier-duty tasks such as scalpmowing could be accomplished. Other commonly used, similarly sized cylindrical devices could be used in place of reel 22 and its associated bedknife, such as a verticutter, vibratory roller, groomer, brush, and the like.

Thus, the scope of this invention is to be limited only by the appended claims.

We claim:

1. An electrically driven turf maintenance machine, which comprises:
(a) a frame;
(b) a plurality of ground engaging wheels attached to the frame for supporting the frame for movement over the ground;
(c) at least one electric motor operatively connected to at least one of the ground engaging wheels for propelling the wheel to provide traction for the frame;
(d) at least one operating unit carried on the frame for performing a turf maintenance operation;
(e) at least one electric motor operatively connected to at least one operating unit for powering the operating unit; and
(f) an electric drive system carried on the frame for providing electric power to the electric motors, the electric drive system comprising:
(i) a fuel cell capable of converting hydrogen gas into electric power; and
(ii) an electrical storage system for storing electric power.

2. The machine of claim 1, wherein the machine comprises a grass mowing machine, and wherein the operating unit comprises a grass cutting unit.

3. The machine of claim 1, wherein the electrical storage system comprises an ultracapacitor pack.

4. A reel type cutting unit of a mower, which comprises:
(a) a cutting unit frame comprising a pair of laterally spaced side plates;
(b) a rotatable cutting reel cooperable with a fixed bedknife to sever grass, the cutting reel being rotatably journalled in the side plates for rotation between the side plates;
(c) an electric motor carried on an exterior of one of the side plates for powering the cutting reel, the electric motor comprising:
(i) a motor housing having a rotatable motor armature;
(ii) an output shaft driven from the motor armature with the output shaft being coupled to the cutting reel for rotating the cutting reel; and
(iii) wherein the output shaft is lower than the motor armature when the output shaft is coupled to the cutting reel.

5. The cutting unit of claim 4, wherein the output shaft is contained in a housing that is integral with the motor housing and extends downwardly from the motor housing.

6. The cutting unit of claim 5, wherein the output shaft is driven at a slower speed than the motor armature and the housing that contains the output shaft is a speed reduction housing.

7. The cutting unit of claim 4, further including an electronics housing that is integral with the motor housing, wherein the electronics housing contains the electronics for controlling and powering the motor.

8. The cutting unit of claim 7, wherein a substantial portion of the electronics housing stands off the motor housing to be separated from the motor housing by a gap or space.

9. The cutting unit of claim 4, further including a counterbalance to the weight of the electric motor which counterbalance is carried on an opposite side plate of the reel cutting unit.

10. The cutting unit of claim 9, wherein the counterbalance is a counterweight.

11. An electric motor for powering a rotatable cutting reel of a reel type cutting unit of a mower, which comprises:
(a) a motor housing having a rotatable motor armature, wherein the motor armature is operatively coupled to the cutting reel for rotating the cutting reel; and
(b) an electronics housing that is integral with the motor housing, wherein the electronics housing contains the electronics for controlling and powering the motor.

12. The electric motor of claim 11, wherein a substantial portion of the electronics housing stands off the motor housing to be separated from the motor housing by a gap or space.

13. A mower, which comprises:
(a) a frame;
(b) a plurality of ground engaging wheels attached to the frame for supporting the frame for movement over the ground;
(c) a traction system operatively connected to at least one of the ground engaging wheels for propelling the wheel to provide traction for the frame;
(d) at least one grass cutting unit carried on the frame for cutting grass;
(e) a lift and lower system for lifting the cutting unit out of engagement with the ground and for lowering the cutting unit into engagement with the ground; and
(f) an actuator for powering the lift and lower system during lifting of the cutting units out of engagement with the ground with the actuator being unpowered during lowering of the cutting units into engagement with the ground.

14. The mower of claim 13, wherein the lift and lower system comprises a hydraulic cylinder connected to the cutting unit, and wherein the actuator comprises a pump for pumping hydraulic fluid to the hydraulic cylinder to raise the cutting unit out of engagement with the ground, the pump being driven only when hydraulic fluid is being pumped to the hydraulic-cylinder.

15. The mower of claim 14, wherein the pump is electrically driven.

16. The mower of claim 14, wherein a reservoir of hydraulic fluid, the pump and a valve controlling flow through at least one outlet are packaged together as a single integrated actuator.
